(19) United States
(12) Patent Application Publication
(10) Pub. No.: US 2022/0146422 A1
(43) Pub. Date: May 12, 2022

(54) INTERFEROMETRIC SENSORS FOR BIOCHEMICAL TESTING

(71) Applicant: Access Medical Systems, LTD., Palo Alto, CA (US)

(72) Inventors: Jianbo Yao, Shanghai (CN); Hong Tan, San Jose, CA (US)

(21) Appl. No.: 17/648,871

(22) Filed: Jan. 25, 2022

Related U.S. Application Data
(63) Continuation of application No. PCT/US2020/043555, filed on Jul. 24, 2020.
(60) Provisional application No. 62/879,086, filed on Jul. 26, 2019.

(51) Int. Cl. G01N 21/45

(52) U.S. Cl. CPC G01N 21/45; G01N 2021/458; G01N 2201/08; G01N 2201/062

(57) ABSTRACT

Introduced here are interferometric sensors that can be used to conduct biochemical tests. Each interferometric sensor includes an interference layer that is secured along the surface of a monolithic substrate. Analyte-binding molecules can be coated along the surface of the interference layer. Over the course of a biochemical test, a biolayer will form as analyte molecules in a sample bind to the analyte-binding molecules. The refractive index of the monolithic substrate is higher than the refractive index of the interference layer. Moreover, the interference layer may be designed such that its refractive index is substantially similar to the refractive index of the biolayer.

### CROSS-REFERENCE TO RELATED APPLICATIONS

This application is a continuation of International Application No. PCT/US2020/043555, filed on Jul. 24, 2020, which claims priority to U.S. Provisional Application No. 62/879,086, filed on Jul. 26, 2019, each of which is incorporated by reference herein in its entirety.

### FIELD OF THE INVENTION

Various embodiments concern interferometric sensors to which analyte molecules in a sample can bind over the course of a biochemical test.

### BACKGROUND

Diagnostic tests based on binding events between analyte molecules and analyte-binding molecules are widely used in medical, veterinary, agricultural, and research applications. These diagnostic tests can be employed to detect whether analyte molecules are present in a sample, the amount of analyte molecules in a sample, or the rate of binding of analyte molecules to the analyte-binding molecules. Together, an analyte-binding molecule and its corresponding analyte molecule form an analyte-anti-analyte binding pair (or simply “binding pair”). Examples of binding pairs include complementary strands of nucleic acids, antigen-antibody pairs, and receptor-receptor binding agents. The analyte can be either member of the binding pair, and the anti-analyte can be the other member of the binding pair.

Historically, diagnostic tests have employed a solid, planar surface having analyte-binding molecules immobilized thereon. Analyte molecules in a sample will bind to these analyte-binding molecules with high affinity in a defined detection zone. In this type of assay, known as a “solid-phase assay,” the solid surface is exposed to the sample under conditions that promote binding of the analyte molecules to the analyte-binding molecules. Generally, the binding events are detected directly by measuring changes in mass, reflectivity, thickness, color, or another characteristic indicative of a binding event. For example, when an analyte molecule is labeled with a chromophore, fluorescent label, or radiolabel, the binding events are detectable based on how much, if any, label can be detected within the detection zone. Alternatively, the analyte molecule could be labeled after it has bound to an analyte-binding molecule within the detection zone.

U.S. Pat. No. 5,804,453 discloses a method of determining the concentration of a substance in a sample solution, using a fiber optic having a reagent (i.e., a capturing molecule) coated directly at its distal end to which the substance binds. The distal end is then immersed into the sample containing the analyte. Binding of the analyte to the reagent layer generates an interference pattern and is detected by a spectrometer.

U.S. Pat. No. 7,394,547 discloses a biosensor that a first optically transparent element is mechanical attached to an optic fiber tip with an air gap between them, and a second optical element as the interference layer with a thickness greater than 50 nanometers (nm) is then attached to the distal end of the first element. The biolayer is formed on the peripheral surface of the second optical element. An additional reflective surface layer with a thickness between 5-50 nm and a refractive index greater than 1.8 is coated between the interference layer and the first element. The principle of detecting an analyte in a sample based on the changes of spectral interference is described in this reference, which is incorporated herein by reference.

U.S. Pat. No. 7,319,525 discloses a different configuration in which a section of an optic fiber is mechanically attached to a tip connector consisting of one or more optic fibers with an air gap between the proximal end of the optic fiber section and the tip connector. The interference layer and then the biolayer are built on the distal surface of the optical fiber section.

Although prior art provides functionality in utilizing biosensors based on thin-film interferometers, there exists a need for improvements in the performance of these interferometers.

### BRIEF DESCRIPTION OF THE DRAWINGS

FIG. 1A depicts a biosensor interferometer that includes a light source, a detector, a waveguide, and an optical assembly (also referred to as a “probe”).

FIG. 1B depicts an example of a conventional probe.

FIG. 2 depicts an example of a probe in accordance with various embodiments.

FIG. 3 depicts another example of a probe in accordance with various embodiments.

FIGS. 4A-B illustrate the principles of detection in a thin-film interferometer.

FIG. 5 depicts an example of a slide in accordance with various embodiments.

FIG. 6 depicts another example of a slide in accordance with various embodiments.

FIG. 7 depicts a flow diagram of a process for manufacturing a probe.

FIGS. 8A-C include side, bottom perspective, and top perspective views of a probe in accordance with various embodiments.

FIG. 9 depicts the binding curve (with shift in nm) of Protein A on APS probes with conventional probes assigned to channels (CH) 1-4 (i.e., the bottom four curves) and MgF₂ probes assigned to CH 5-8 (i.e., the top four curves).

FIG. 10 depicts the binding curve of human IgG on Protein A probes with conventional probes assigned to CH 1-4 (i.e., the bottom four curves) and MgF₂ probes assigned to CH 5-8 (i.e., the bottom four curves).

Various features of the technology will become apparent to those skilled in the art from a study of the Detailed Description in conjunction with the drawings. The drawings depict various embodiments described throughout the Detailed Description for the purpose of illustration only. While specific embodiments have been shown by way of example, the technology is amenable to various modifications and alternative forms. The intention is not to limit the technology to the particular embodiments that have been illustrated and/or described.

### DETAILED DESCRIPTION

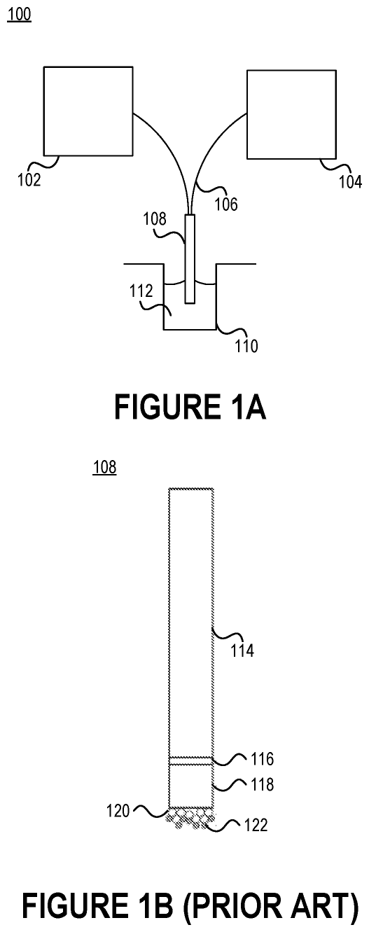

Several entities have developed systems designed to conduct biochemical tests. FIGS. 1A-B illustrate one example of such a system. In particular, FIG. 1A depicts a biosensor interferometer 100 (or simply “interferometer”) that includes a light source 102, a detector 104, a waveguide 106, and an optical assembly 108 (also referred to as a “probe”). The probe 108 may be connected to the waveguide 106 via a coupling medium.

The light source 102 may emit light that is guided toward the probe 108 by the waveguide 106. For example, the light source 102 may be a light-emitting diode (LED) that is configured to produce light over a range of at least 50 nanometers (nm), 100 nm, or 150 nm within a given spectrum (e.g., 400 nm or less to 700 nm or greater). Alternatively, the interferometer 100 may employ a plurality of light sources having different characteristic wavelengths, such as LEDs designed to emit light at different wavelengths in the visible range. The same function could be achieved by a single light source with suitable filters for directing light with different wavelengths onto the probe 108.

The detector 104 is preferably a spectrometer, such as an Ocean Optics USB4000, that is capable of recording the spectrum of interfering light received from the probe 108. Alternatively, if the light source 102 operates to direct different wavelengths onto the probe 108, then the detector 104 can be a simple photodetector capable of recording intensity at each wavelength. In another embodiment, the detector 104 can include multiple filters that permit detection of intensity at each of multiple wavelengths.

The waveguide 106 can be configured to transport light emitted by the light source 102 to the probe 108, and then transport light reflected by surfaces within the probe 108 to the detector 104. In some embodiments the waveguide 106 is a bundle of optical fibers (e.g., single-mode fiber optic cables), while in other embodiments the waveguide 106 is a multi-mode fiber optic cable.

As shown in FIG. 1B, the probe 108 includes a monolithic substrate 114, a thin-film layer (also referred to as an “interference layer”), and a biomolecular layer (also referred to as a “biolayer”) that comprises analyte molecules 122 that have bound to analyte-binding molecules 120. The monolithic substrate 114 comprises a transparent material through which light can travel. The interference layer also comprises a transparent material. When light is shone on the probe 108, the proximal surface of the interference layer may act as a first reflecting surface and the biolayer may act as a second reflecting surface. As further described below, light reflected by the first and second reflecting surfaces may form an interference pattern that can be monitored by the interferometer 100.

The interference layer normally includes multiple layers that are combined in such a manner to improve the detectability of the interference pattern. Here, for example, the interference layer comprises a tantalum pentoxide (Ta₂O₅) layer 116 and a silicon dioxide (SiO₂) layer 118. The tantalum pentoxide layer 116 may be thin (e.g., on the order of 10-40 nm) since its main purpose is to improve reflectivity at the proximal surface of the interference layer. Meanwhile, the silicon dioxide layer 118 may be comparatively thick (e.g., on the order of 650-900 nm) since its main purpose is to increase the distance between the first and second reflecting surfaces.

To perform a diagnostic test, the probe 108 can be suspended in a microwell 110 (or simply “well”) that includes a sample 112. Analyte molecules 122 in the sample 112 will bind to the analyte-binding molecules 120 along the distal end of the probe 108 over the course of the diagnostic test, and these binding events will result in an interference pattern that can be observed by the detector 104. The interferometer 100 can monitor the thickness of the biolayer formed along the distal end of the probe 108 by detecting shifts in a phase characteristic of the interference pattern.

However, such a design has several disadvantages. One drawback is the poor signal strength observed during biochemical tests involving these probes. Another drawback is the negative shift in the binding curve that can occur when the biolayer grows over an extended prior of time (e.g., dozens of cycles occurring over 20-40 minutes).

Introduced here is an interferometric sensor (also referred to as an “interferometric biosensor” or “sensing apparatus”) that addresses these drawbacks. In particular, the interferometric sensor can include a monolithic substrate that has first and second surfaces arranged substantially parallel to one another at opposite ends of the monolithic substrate, an interference layer coated on the second surface of the monolithic substrate, and a layer of analyte-binding molecules coated on the interference layer. The interference layer may comprise magnesium fluoride (MgF₂). A first interface between the monolithic substrate and the interference layer acts as a first reflecting surface when light is shone on the interferometric sensor, while a second interface between a biolayer formed by analyte molecules in a sample binding to the analyte-binding molecules and a solution containing the sample acts as a second reflecting surface when the light is shone on the probe. As described above, the thickness of the biolayer can be estimated based on the interference pattern of light reflected by the first and second reflecting surfaces.

Embodiments of the interferometric sensor may be described in the context of a probe designed to be suspended within a solution containing a sample for the purpose of illustration. However, those skilled in the art will recognize that these features are equally applicable to other sensing surfaces, such as planar surfaces (e.g., a slide) upon which a biolayer is formed by flowing a solution over the planar surface over the course of a biochemical test.

### Definitions

The term “about” means within ±10% of the recited value.

The term “analyte-binding molecule” refers to any molecule capable of participating in a binding reaction with an analyte molecule. Examples of analyte-binding molecules include, but are not limited to, (i) antigen molecules; (ii) antibody molecules; (iii) protein molecules; (iv) ligands; and (v) single-stranded nucleic acid molecules.

The term “interferometric sensor” refers to any sensing apparatus upon which a biolayer formed to produce an interference pattern. One example of an interferometric sensor is a probe designed to be suspended in a solution containing the sample having the analyte molecules. Another example of an interferometric sensor is a slide with a planar surface upon which a biolayer can be formed over the course of a biochemical test.

The term “probe” refers to a monolithic substrate having as aspect ratio (length-to-width) of at least 2 to 1 with a thin-film layer coated on the sensing side.

The term “monolithic substrate” refers to a solid piece of material having a uniform composition, such as glass, quartz, or plastic, with one refractive index.

The term “waveguide” refers to a device (e.g., a duct, coaxial cable, or optic fiber) designed to confine and direct the propagation of electromagnetic waves (as light). One example of a waveguide is a metal tube for channeling ultrahigh-frequency waves.

### Probe Overview

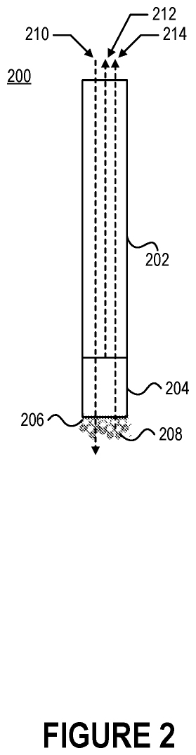

FIG. 2 depicts an example of a probe 200 in accordance with various embodiments. The probe 200 includes an interference layer 204 that is secured along the distal end of a monolithic substrate 202. Analyte-binding molecules 206 can be deposited along the distal surface of the interference layer 204. Over the course of a biochemical test, a biolayer will form as analyte molecules 208 in a sample bind to the analyte-binding molecules 206.

As shown in FIG. 2, the monolithic substrate 202 has a proximal surface (also referred to as a “coupling side”) that can be coupled to, for example, a waveguide of an interferometer and a distal surface (also referred to as a “sensing side”) on which additional layers are deposited. Generally, the monolithic substrate 202 has a length of at least 3 millimeters (mm), 5 mm, 10 mm, or 15 mm. In a preferred embodiment, the aspect ratio (length-to-width) of the monolithic substrate 202 is at least 5 to 1. In such embodiments, the monolithic substrate 202 may be said to have a columnar form. The cross section of the monolithic substrate 202 may a circle, oval, square, rectangle, triangle, pentagon, etc. The monolithic substrate 202 preferably has a refractive index that is substantially higher than the refractive index of the interference layer 204, such that the proximal surface of the interference layer 204 effectively reflects light directed onto the probe 200. The preferred refractive index of the monolithic substrate may be higher than 1.5, 1.8, or 2.0. Accordingly, the monolithic substrate 202 may comprise a high-refractive-index material such as glass (refractive index of 2.0), though some embodiments of the monolithic substrate 202 may comprise a low-refractive-index material such as quartz (refractive index of 1.46) or plastic (refractive index of 1.32-1.49). Examples of transparent plastics include polypropylene, polyurethane, acrylic, polycarbonate, and the like.

The interference layer 204 comprises at least one transparent material that is coated on the distal surface of the monolithic substrate 202. These transparent material(s) are deposited on the distal surface of the monolithic substrate 202 in the form of thin films ranging in thickness from fractions of a nanometer (e.g., a monolayer) to several micrometers. The interference layer 204 may have a thickness of at least 500 nm, 700 nm, or 900 nm. An exemplary thickness is between 500-5,000 nm (and preferably 800-1,200 nm). Here, for example, the interference layer 204 has a thickness of approximately 900-1,000 nm, or 940 nm.

In contrast to conventional probes, the interference layer 204 has a substantially similar refractive index as the biolayer. This ensures that the reflection from the distal end of the probe 200 is predominantly due to the analyte molecules 208 rather than the interface between the interference layer 204 and the analyte-binding molecules 206. Generally, the biolayer has a refractive index of approximately 1.36, though this may vary depending on the type of analyte-binding molecules (and thus analyte molecules) along the distal end of the probe 200.

In some embodiments the interference layer 204 comprises magnesium fluoride (MgF₂), while in other embodiments the interference layer 204 comprises potassium fluoride (KF) with a refractive index of 1.36, lithium fluoride (LiF) with a refractive index of 1.39, sodium fluoride (NaF) with a refractive index of 1.32, lithium calcium aluminum fluoride (LiCaAlF₆) with a refractive index of 1.39, strontium fluoride (SrF₂) with a refractive index of 1.37, aluminum fluoride (AlF₃) with a refractive index of 1.38, sodium aluminum hexafluoride (Na₃AlF₆) (also referred to as “cryolite”) with a refractive index of 1.34, sodium aluminum fluoride (Na₅Al₃F₁₄) (also referred to as “chiolite”) with a refractive index of 1.34, etc. Additionally or alternatively, the interference layer 204 could comprise a polymer with a refractive index less than 1.4, such as FICOLL® (copolymers of sucrose and epichlorohydrin). Magnesium fluoride has a refractive index of 1.38, which is substantially identical to the refractive index of the biolayer formed along the distal end of the probe 200. For comparison, the interference layer of conventional probes normally comprises silicon dioxide, and the refractive index of pure silicon dioxide is approximately 1.46. Less pure forms of silicon dioxide have high refractive indices (e.g., around 1.5 in the visible range). Generally, the refractive index of the interference layer 204 is between 1.32 and 1.42, between 1.36 and 1.42, or between 1.38 and 1.40. Because the interference layer 204 and biolayer have similar refractive indexes, light will experience minimal scattering as it travels from the interference layer 204 into the biolayer and then returns from the biolayer into the interference layer 204.

The thickness of the biolayer is designed to optimize the overall sensitivity based on the hardware (e.g., the optical components) of the interferometer. Conventional immobilization chemistries can be used to covalently (e.g., chemically) or non-covalently (e.g., by adsorption) attach the analyte-binding molecules 206 to the distal surface of the interference layer 204.

The layer of analyte-binding molecules 206 is preferably formed under conditions in which the distal end of the probe 200 is densely coated, so that binding of analyte molecules 208 to the analyte-binding molecules 206 results in a change in the thickness of the biolayer rather than filling in the layer. The layer of analyte-binding molecules 206 can be a monolayer or a multi-layer matrix.

During a biochemical test, the probe 200 can be suspended within a cavity (e.g., a well) that includes a sample. An example of probe-based detection technologies is described in U.S. Pat. No. 8,597,578, titled “Optical Sensor of Bio-Molecules using Thin-Film Interferometer,” which is incorporated by reference herein in its entirety. Over the course of the biochemical test, a biolayer will form along the distal end of the probe 200 as analyte molecules 208 bind to the analyte-binding molecules 206.

When light is shone on the probe 200, the proximal surface of the interference layer 204 may act as a first reflecting surface and the distal surface of the biolayer may act as a second reflecting surface. The presence, concentration, or binding rate of analyte molecules 208 to the probe 200 can be estimated based on the interference of beams of light reflected by these two reflecting surfaces. As analyte molecules 208 attach to (or detach from) the analyte-binding molecules 206, the distance between the first and second reflecting surfaces will change. Because the dimensions of all other components in the probe 200 remain the same, the interference pattern formed by the light reflected by the first and second reflecting surfaces is phase shifted in accordance with changes in biolayer thickness due to binding events.

The use of a monolithic substrate 202 instead of an optical fiber provides several advantages. As noted above, the refractive index of the monolithic substrate 202 is preferably higher than the refractive index of the interference layer 204. For example, the refractive index of the monolithic substrate 202 may be at least 0.1, 0.2, 0.4, 0.5, or 0.6 higher than the refractive index of the interference layer 204. Because the monolithic substrate 202 is a solid piece of material having a uniform composition, it is easier to select a material having a higher refractive index than that of the interference layer 204. Conversely, an optical fiber is typically a circular cross-section dielectric waveguide having a dielectric material (also referred to as a “core material”) that is surrounded by another dielectric material with a lower refractive index (also referred to as “cladding”), which makes it difficult to manipulate its refractive index.

In operation, an incident light signal 210 emitted by a light source is transported through the monolithic substrate 202 toward the biolayer. Within the probe 200, light will be reflected at the first reflecting surface resulting in a first reflected light signal 212. Light will also be reflected at the second reflecting surface resulting in a second reflected light signal 214. The second reflecting surface initially corresponds to the interface between the analyte-binding molecules 206 and the sample in which the probe 200 is immersed. As binding occurs during the biochemical test, the second reflecting surface becomes the interface between the analyte molecules 208 and the sample.

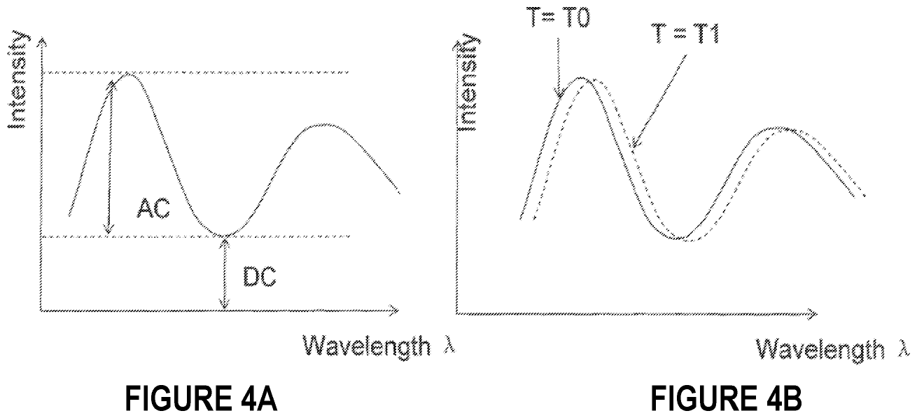

The first and second reflected light signals 212, 214 form a spectral interference pattern, as shown in FIG. 4A. When analyte molecules 208 bind to the analyte-binding molecules 206 on the distal surface of the interference layer 204, the optical path of the second reflected light signal 214 will lengthen. As a result, the spectral interference pattern shifts from T0 to T1 as shown in FIG. 4B. By measuring the phase shift continuously in real time, a kinetic binding curve can be plotted as the amount of shift versus the time. The association rate of an analyte molecule to an analyte-binding molecule immobilized on the distal surface of the interference layer 204 can be used to calculate analyte concentration in the sample. Hence, the measure of the phase shift is the detection principle of a thin-film interferometer.

Referring to FIG. 4A, the performance of a thin-film interferometer can be improved by maximizing the alternating current (AC) component and minimizing the direct current (DC) offset. Said another way, performance of a thin-film interferometer can be improved by increasing the AC-to-DC ratio since the AC component represents the signal of interest while the DC offset represents noise. To achieve these objectives, one can (1) increase the efficiency with which the incident light signal 210 and reflected light signals 212, 214 travel through the probe 200; (2) increase the coupling efficiency between the light source and probe 200; and/or (3) increase the coupling efficiency between the spectrometer and probe 200.

Substantially matching the refractive indices of the interference layer 204 and biolayer accomplishes the first of these goals, namely, by reducing reflection from other surfaces within the probe 200 (e.g., the interface between the interference layer 204 and analyte-binding molecules 206) as much as possible. As the refractive index of the interference layer 204 approaches the refractive index of the biolayer (e.g., 1.38 for interference layer 204 and 1.36 for biolayer), the shift in the spectral interference pattern as the biolayer is built up will increase. This is because the delta between T0 and T1 is based on the difference between the refractive indices of the interference layer 204 and the surrounding materials (e.g., the sample). Note, however, that as the refractive index of the interference layer 204 decreases, so too will the magnitude of T0 and T1. There is a tradeoff between magnitude and shift in the spectral interference pattern. At a high level, the goal is to have a large enough magnitude that two peaks can be identified while having those peaks separated as much as possible. As an example, lowering the refractive index of the interference layer 204 will result in more shift but a smaller AC-to-DC ratio (i.e., a larger DC component and/or smaller AC component resulting in the signal being “noisier”).

In some embodiments, a reflection layer (not shown) is deposited along the distal end of the monolithic substrate 202 such that the reflection layer is positioned between the monolithic substrate 202 and interference layer 204. Since its main purpose is to ensure that the first reflected light signal 212 reflects at the interface between the monolithic substrate 202 and interference layer 204, the reflection layer may comprise a material having a higher refractive index than either the monolithic substrate 202 or interference layer 204. For example, the reflection layer may comprise zinc sulfide (ZnS) with a refractive index of 2.3-2.4, titanium dioxide (TiO₂) with a refractive index of 2.3-2.4, titanium monoxide (TiO) with a refractive index of 2.2-2.3, dititanium trioxide (Ti₂O₃) with a refractive index of 1.9-2.3, titanium oxide (Ti₃O₅) with a refractive index of 2.2-2.3, tantalum oxide (Ta₂O₃) with a refractive index of 216, tantalum pentoxide (Ti₃O₅) with a refractive index of 2.16, silicon monoxide (SiO) with a refractive index of 1.8-1.9, aluminum sesquioxide (Al₂O₃) with a refractive index of 1.67, zirconium dioxide (ZrO₂) with a refractive index of 1.97-2.05, zinc monoxide (ZnO) with a refractive index of 2.01, lanthanum titanium trioxide (LaTiO₃) with a refractive index of 2.1, indium tin oxide (ITO) with a refractive index of 1.8, niobium pentoxide (Nb₂O₅) with a refractive index of 2.1-2.3, zinc selenide (ZnSe) with a refractive index of 2.58, cerium dioxide (CeO₂) with a refractive index of 2.35, yttrium oxide (Y₂O₃) with a refractive index of 1.87, hafnium oxide (HfO₂) with a refractive index of 1.95, or gadolinium oxide (Gd₂O₃) with a refractive index of 1.8. The reflection layer may be very thin in comparison to the interference layer 204. For example, the reflection layer may have a thickness of approximately 3-10 nm.

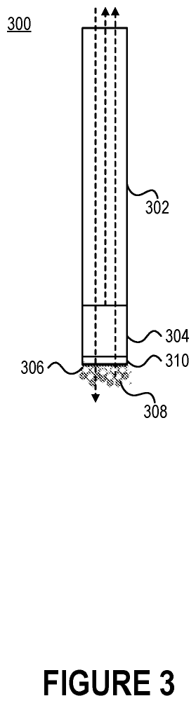

FIG. 3 depicts another example of a probe 300 in accordance with various embodiments. Probe 300 of FIG. 3 may be substantially similar to probe 200 of FIG. 2. Here, however, the probe 300 includes an adhesion layer 310 that is deposited along the distal surface of the interference layer 304 affixed to the monolithic substrate 302. The adhesion layer 310 may comprise a material that promotes adhesion of the analyte-binding molecules 306. One example of such a material is silicon dioxide. The adhesion layer 310 is generally very thin in comparison to the interference layer 304, so its impact on light traveling toward, or returning from, the biolayer will be minimal. For example, the adhesion layer 310 may have a thickness of approximately 3-10 nm, while the interference layer 304 may have a thickness of approximately 800-1,000 nm. The biolayer formed by the analyte-binding molecules 306 and analyte molecules 308 will normally have a thickness of several nm. Much like probe 200 of FIG. 2, probe 300 of FIG. 3 may also have a reflection layer (not shown) deposited along the distal end of the monolithic substrate 302 such that the reflection layer is positioned between the monolithic substrate 302 and interference layer 304. The thickness of the reflection layer may be about the same as the thickness of the adhesion layer 310.

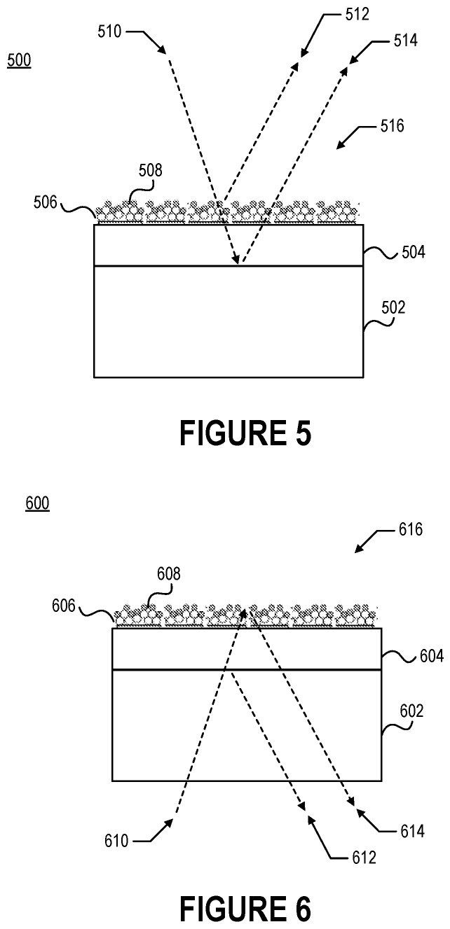

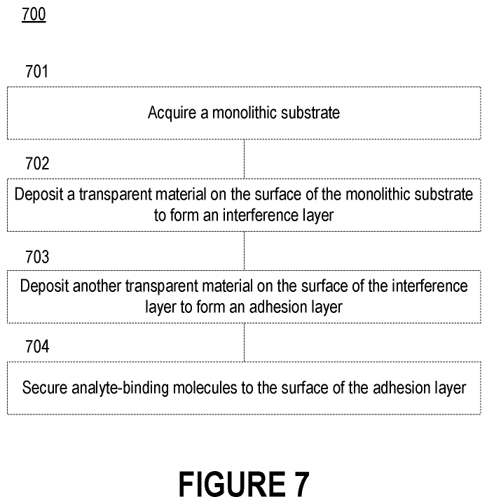

As mentioned above, these features are equally applicable to sensing surfaces having other forms. One example of such a sensing surface is a slide (also referred to as a “chip”) with a planar surface upon which a biolayer is formed by flowing a solution over the planar surface over the course of a biochemical test. Several examples of planar surfaces are discussed below with reference to FIGS. 5-6.

FIG. 5 depicts an example of a slide 500 in accordance with various embodiments. The slide 500 includes a substrate 502 upon which an interference layer 504 is deposited. In some embodiments the interference layer 504 is deposited along the entire upper surface of the substrate 502, while in other embodiments the interference layer 504 is deposited along a portion of the upper surface of the substrate 502. For example, the interference layer 504 may be deposited within channels or wells formed within the upper surface of the substrate 502. As discussed above, monolithic substrates 202, 302 of FIGS. 2-3 are generally much larger in height than in width. Here, however, the inverse may be true. In fact, the width of the substrate 502 may be larger than the length by a factor of 5, 7.5, 10, or 20. As an example, the substrate may be approximately 75 by 26 mm with a height/thickness of roughly 1 mm.

Over the course of a diagnostic test, analyte molecules 508 can bind to analyte-binding molecules 506 that have been secured along the upper surface of the interference layer 504 to form a biolayer. To establish the thickness of the biolayer, light can be shone at the upper surface of the slide 500 as shown in FIG. 5. More specifically, an incident light signal 510 emitted by a light source can be shown at the biolayer that has formed along the upper surface of the slide 500. This may require that the incident light signal 510 travel through ambient media 516, which may be vacuum, air, or solution. The incident light signal 510 will be reflected at a first reflecting surface resulting in a first reflected light signal 512. The first reflecting surface may be representative of the interface between the biolayer and ambient media 516. The incident light signal 510 will also be reflected at a second reflecting surface resulting in a second reflected light signal 514. The second reflecting surface may be representative of the interface between the interference layer 504 and substrate 502. As discussed above, the first and second reflected light signals 512, 514 form a spectral interference pattern that can be analyzed to establish the thickness of the biolayer. Note that because the incident light signal 510 is not transported through the substrate 502, the substrate 502 could be either transparent or non-transparent (e.g., opaque).

FIG. 6 depicts another example of a slide 600 in accordance with various embodiments. Slide 600 of FIG. 6 may be largely similar to slide 500 of FIG. 5. Thus, the slide 600 may include a substrate 602 upon which an interference layer 604 and analyte-binding molecules 606 are deposited. Over the course of a diagnostic test, analyte molecules 608 can bind to the analyte-binding molecules 606 to form a biolayer.

Here, however, the incident light signal 610 is shown at the lower surface of the slide 600. In operation, the incident light signal 610 is transported through the substrate 602 toward the biolayer. Within the slide 600, light will be reflected at a first reflecting surface resulting in a first reflected light signal 612. The first reflecting surface may be representative of the interface between the interference layer 604 and substrate 602. Light will also be reflected at a second reflecting surface resulting in a second reflected light signal 614. The second reflecting surface may be representative of the interface between the biolayer and ambient media 616. As discussed above, the first and second reflected light signals 612, 614 form a spectral interference pattern that can be analyzed to establish the thickness of the biolayer.

While not shown in FIGS. 5-6, the slides 500, 600 could include a reflection layer that is disposed between the substrate 502, 602 and interference layer 504, 604 to improve reflectivity along that interface and/or an adhesion layer that is disposed along the upper surface of the interference layer 504, 604 to secure the analyze-binding molecules 506, 606.

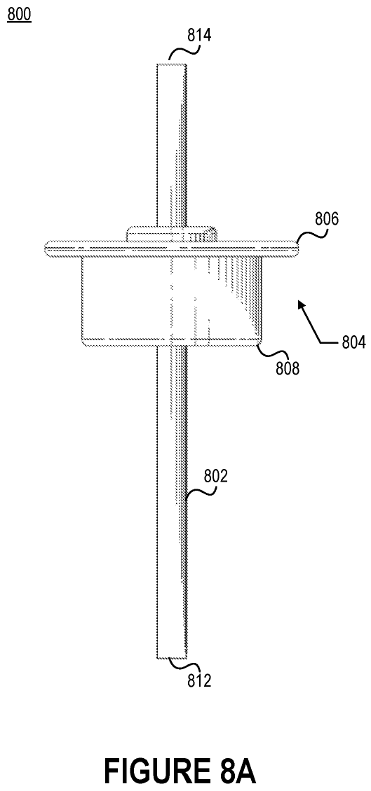

FIG. 7 depicts a flow diagram of a process 700 for manufacturing an interferometric sensor. Initially, a manufacturer acquires a monolithic substrate (step 701). For example, the manufacturer may select the monolithic substrate from amongst multiple monolithic substrates designed for different biochemical tests, analyte-binding molecules, etc. The preferred refractive index of the monolithic substrate may be higher than 1.5, 1.8, or 2.0. Accordingly, the monolithic substrate acquired by the manufacturer may comprise a high-refractive-index material, such as glass (refractive index of 2.0), or a low-refractive-index material, such as quartz (refractive index of 1.46) or plastic (refractive index of 1.32-1.49). As discussed above, in some embodiments the monolithic substrate has a columnar form (e.g., monolithic substrates 202, 302 of FIGS. 2-3) while in other embodiments the monolithic substrate has a planar form (e.g., monolithic substrates 502, 602 of FIGS. 5-6).

The manufacturer can then deposit a transparent material on the surface of the monolithic substrate to form an interference layer (step 702). For example, the transparent material may be deposited onto the distal surface of the monolithic substrate in the form of a thin film ranging in thickness from fractions of a nanometer (e.g., a monolayer) to several micrometers. Normally, the interference layer has a thickness of at least 500 nm, 700 nm, or 900 nm. An exemplary thickness is between 500-5,000 nm (and preferably 800-1,200 nm).

In some embodiments, the manufacturer deposits another transparent material on the surface of the interference layer to form an adhesion layer (step 703). The adhesion layer may comprise a material that promotes adhesion of analyte-binding molecules. One example of such a material is silicon dioxide. The adhesion layer is generally very thin in comparison to the interference layer, so its impact on light traveling along the interferometric sensor will be minimal. For example, the adhesion layer may have a thickness of approximately 3-10 nm.

Thereafter, the manufacturer can secure analyte-binding molecules to the surface of the adhesion layer (step 704). As discussed above, a layer of analyte-binding molecules can be formed under conditions in which the surface of the interferometric sensor (e.g., the distal end of a probe, or the distal surface of a planar chip) is densely coated. This ensures that as analyte molecules bind to the analyte-binding molecules over the course of a biochemical test, these binding events result in a change in the thickness of the biolayer rather than filling in the layer of analyte-binding molecules. The layer of analyte-binding molecules can be a monolayer or a multi-layer matrix.

Unless contrary to physical possibility, it is envisioned that the steps described above may be performed in various sequences and combinations. For example, the manufacturer may choose not to create an adhesion layer along the distal surface of the interference layer. In such embodiments, the analyte-binding molecules may be secured directly to the distal surface of the interference layer.

Additional steps may also be performed. For example, the manufacturer may form a reflection layer on the surface of the monolithic substrate. As discussed above, the reflection layer may comprise a transparent material that has a higher refractive index than the monolithic substrate and the interference layer. Because of its location, this transparent material may be deposited onto the surface of the monolithic substrate before the interference layer is formed (i.e., before step 702 is performed). As another example, the manufacturer may cure the interference layer (e.g., using heat, air, radiation, etc.) before forming the adhesion layer. Similarly, the manufacturer may cure (i) the reflection layer before securing the adhesion layer thereto and/or (ii) the adhesion layer before securing the analyte-binding molecules thereto. As another example, the manufacturer may polish first and second surfaces of the monolithic substrate that are arranged substantially parallel to one another at opposite ends of the monolithic substrate. Polishing may be performed to improve adhesion of the interference layer to the monolithic substrate.

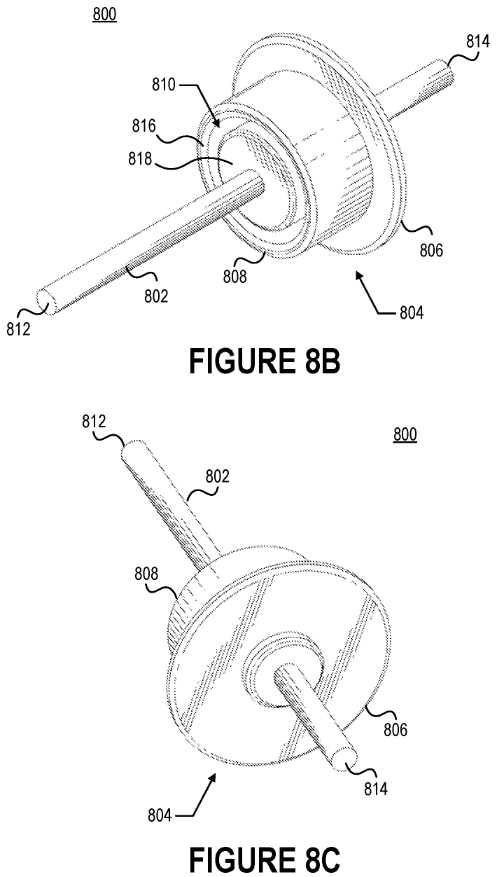

FIG. 8A includes a side view of a probe 800 in accordance with various embodiments. FIG. 8B includes a bottom perspective view of the probe 800, while FIG. 8C includes a top perspective view of the probe 800. The probe 800 comprises a rod section 802 (also referred to as a “rod component”) and a flexible support component 804 (also referred to as a “flexible skirt”). The flexible support component 804 can be centrally located along the length of the rod section 802 such that a first portion of the rod section 802 extends from a top side of the flexible support component 804 and a second portion of the rod section 802 extends from a bottom side of the flexible support component 804. Thus, the flexible support component 804 may be located in a central portion of the rod section 802.

The rod section 802 may be a monolithic substrate, such as the monolithic substrate 202 of FIG. 2. The rod section 802 may have a length of at least 3 mm, 5 mm, 10 mm, or 15 mm. Note that the first and second portions of the rod section 802 may be different sizes. For example, the first portion of the rod section 802 extending from the top side of the flexible support component 804 may be 2-5 mm, while the second portion of the rod section 802 extending from the bottom side of the flexible support component 804 may be 5-10 mm.

The flexible support component 804 can include a flange section 806 and a sleeve section 808. In some embodiments, the flange section 806 and the sleeve section 808 are joined to one another following production of each component. In other embodiments, the flange section 806 and the sleeve section 808 are part of a single component formed via a molding process, extruding process, etc. The flexible support component 804 can partially or entirely comprise silicone rubber, nitrile rubber, or some other elastomer. For example, in some embodiments the entire flexible support component 804 comprises a flexible material, while in other embodiments only the flange section 806 comprises a flexible material.

As shown in FIG. 8B, the bottom side of the flexible support component 804 can include a depression 810 defined by an inner concave surface 816. An inner extension feature 818 located in the depression 810 can be secured around the rod section 802. In embodiments that include the inner extension feature 818, the depression 810 may take the form of an annular depression that extends radially about the rod section 802.

As described above, the distal end 812 (also referred to as the “bottom end”) of the rod section 802 may have an interference layer secured thereon, and analyte-binding molecules can be coated on the interference layer. Over the course of a biochemical test, a biolayer will form as analyte molecules in a sample bind to the analyte-binding molecules. When light is shone on the proximal end 814 of the probe 800, the proximal surface of the interference layer may act as a first reflecting surface and the biolayer may act as a second reflecting surface.

When the probe 800 is loaded into a well, pressure is applied by the top surface of the well against the bottom side of the flange section 806 of the flexible support component 804. Such pressure causes the distal end 812 of the rod section 802 to be suspended in the well. The flange section 806 can be designed to prevent the distal end 812 of the rod section 802 from touching an inner surface of the well when loaded into the well. The well may be included in a cartridge that includes multiple wells arranged in a linear format or a microplate that includes multiple wells arranged in a grid format.

### REMARKS

The foregoing description of various embodiments of the technology has been provided for the purposes of illustration and description. It is not intended to be exhaustive or to limit the claimed subject matter to the precise forms disclosed.

Many modifications and variation will be apparent to those skilled in the art. Embodiments were chosen and described in order to best describe the principles of the technology and its practical applications, thereby enabling others skilled in the relevant art to understand the claimed subject matter, the various embodiments, and the various modifications that are suited to the particular uses contemplated.

### EXAMPLES

The invention is illustrated further by the following examples that are not to be construed as limiting the invention in scope to the specific procedures described in them.

### Example 1. Preparation of Conventional Probe (SiO₂ Probe)

A conventional probe is shown in FIG. 1B. Both ends of quartz (refractive index 1.46) rods with 20 mm in length and 1 mm in diameter were polished to mirror surfaces using an optical polishing machine. After the rods were washed and cleaned in purified water, they were arrayed in a fixture that is then loaded into an ion-beam assisted physical vapor deposition (PVD) machine. In the PVD machine, an electron beam is used to bombard and vaporize a target material to be coated onto the surface; an ion beam is then applied to deposit the vapor on to the surface to form a thin film layer. These quartz rods were coated first with a 20-nm Ta₂O₅ layer, followed by a 730-nm SiO₂ layer. After the surface was coated with the Ta₂O₅/SiO₂ layers, the rods were place in a chemical vapor deposition (CVD) machine (such as Lab Kote made by Yield Engineering) to coat a thin layer of aminopropyl triethoxysilane (APS). The APS layer is typically 1-2 nm in thickness. APS is deposited to enable protein immobilization. APS adsorbs protein to the surface of the probe by a combination of hydrophobic and ionic interaction. Protein can also be coupled to the amino group of APS by covalent coupling using a crosslinking reagent. APS is only a monolayer, and thus may be about 7 nm thick.

### Example 2A. Preparation of Probe of One Embodiment of the Present Invention (FIG. 3)

An example of the probe of the present invention is shown in FIG. 3. The probe may be referred to as the “MgF₂ probe” or “MgF₂-APS probe.” Both ends of glass (refractive index 2.0) rods with 20 mm in length and 1 mm in diameter were polished to mirror surfaces using an optical polishing machine. After the rods were washed and cleaned in purified water, they were arrayed in a fixture that is then loaded into an ion-beam-assisted physical vapor deposition (PVD) machine. In the PVD machine, an electron beam is used to bombard and vaporize a target material to be coated onto the surface; an ion beam is then applied to deposit the vapor on to the surface to form a thin film layer. The glass rods were coated first with a 940-nm MgF₂ layer, followed by a 5-nm SiO₂ layer. After the surface was coated with the MgF₂/SiO₂ layers, the rods were place in a chemical vapor deposition (CVD) machine to coat a thin layer of APS that is typically 1-2 nm in thickness.

### Example 2B. Preparation of Probe of Another Embodiment of the Present Invention (FIG. 2)

Another example of the probe of the present invention is shown in FIG. 2. The probe may be referred to as the “MgF₂ probe” or “MgF₂-APS probe.” Both ends of glass (refractive index 2.0) rods with 20 mm in length and 1 mm in diameter were polished to mirror surfaces using an optical polishing machine. After the rods were washed and cleaned in purified water, they were arrayed in a fixture that is then loaded into an ion-beam-assisted physical vapor deposition (PVD) machine. In the PVD machine, an electron beam is used to bombard and vaporize a target material to be coated onto the surface; an ion beam is then applied to deposit the vapor on to the surface to form a thin film layer. The glass rods were coated with a single layer of 940-nm MgF₂, without a thin layer of SiO₂ layer. After the surface was coated with the MgF₂ layers, the rods were place in a chemical vapor deposition (CVD) machine to coat a thin layer of APS that is typically 1-2 nm in thickness.

### Example 3. Comparison of Protein A Binding Between MgF₂ Probe and Conventional Probe

For a side-by-side comparison study, the conventional APS probe (Example 1) and MgF₂-APS probe (Example 2A) were immobilized with protein A for binding test.

The two types of probes went through three steps in 96 well plates as shown in Table 1.

TABLE 1
Binding Test Parameters.

| | | Volume | Shaking speed | Time |
|---|---|---|---|---|
| Steps | Reagent | (μL) | (rpm) | (sec) |
| 1 | PBS | 200 | 1000 | 60 |
| 2 | 100 μg/mL | 200 | 1000 | 300 |
| | Protein A | | | |
| | in PBS | | | |
| 3 | PBS | 200 | 1000 | 30 |

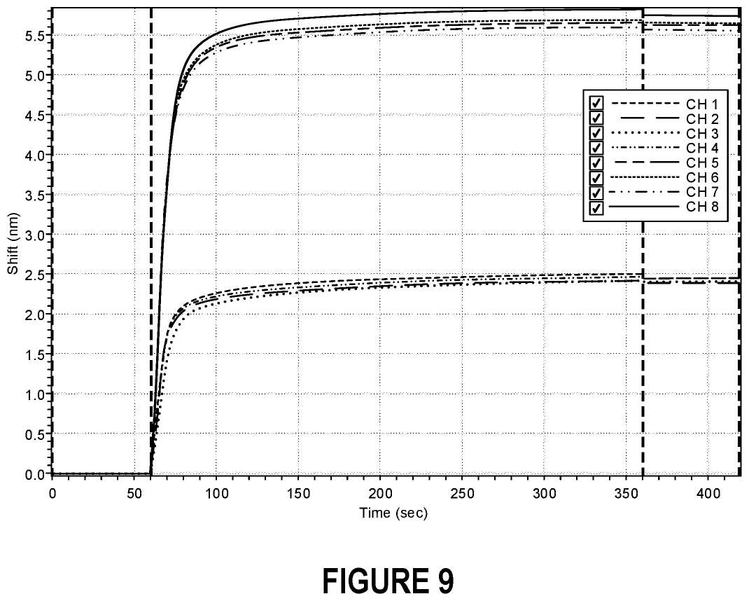

The experiment was conducted using the Gator interferometer instrument from Probe Life, Inc. with software version 1.3. The results are shown in FIG. 9 and summarized in Table 2. FIG. 9 depicts the binding curve (with shift in nm) of Protein A on APS probes with conventional probes assigned to channels (CH) 1-4 (i.e., the bottom four curves) and MgF₂ probes assigned to CH 5-8 (i.e., the top four curves).

TABLE 2
Binding Signal Results

| | Binding Signal (nm shift) of Protein A |
|---|---|
| Conventional Probe | 2.5 nm |
| MgF₂ Probe | 5.6 nm |

The results demonstrate that MgF₂-APS probes gave more than 2.24 fold more binding signal (nm shift) in comparison to conventional probes, as shown by the upper limit of the wavelength shift in nm.

### Example 4. Comparison of IgG/Protein A Binding Between MgF₂ Probe and Conventional Probe

Because Protein A has five Ig-binding domains, and it binds the heavy chain within the Fc region and also within the Fab region in the case of the human VH3 family, we could repetitively immobilize human IgG (Equitech-Bio SLH56) and Protein A on the probe surface to test the upper limit of nm shift.

The two APS probes (conventional probe, Example 1; and MgF₂ probe, Example 2A) went through step 1 to 4 cyclically for 50 times in a 96 well plate:
1. K buffer (PBS, 0.02% BSA, 0.002% Tween-20, 200 μL) for 10 second under 1000 rpm
2. 2 μg/mL whole human IgG in K buffer (200 μL) for 60 seconds under 1000 rpm
3. K buffer (200 μL) for 10 second under 1000 rpm
4. 10 μg/mL protein A in K buffer (200 μL) for 60 second under 1000 rpm

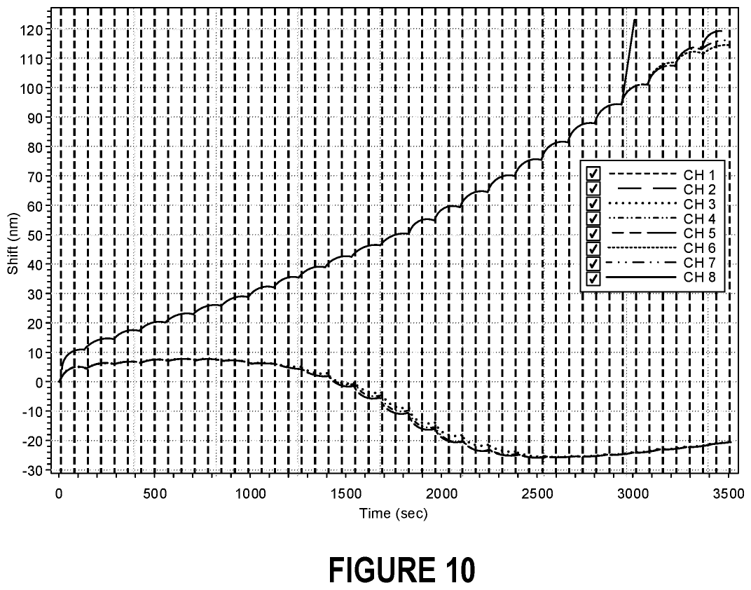

The experiment was conducted using the Gator instrument from Probe Life, Inc and software version 1.3. The results are shown in FIG. 10. In particular, FIG. 10 depicts the binding curve of human IgG on Protein A probes with conventional probes assigned to CH 1-4 (i.e., the bottom four curves) and MgF₂ probes assigned to CH 5-8 (i.e., the top four curves).

The results of FIG. 10 show that MgF₂ probes reached 120 nm wavelength shift without turning to negative shift while conventional probe only reached 7 nm wavelength shift before starting to show negative nm shift. The signal (nm shift) was much higher with the MgF₂ probe than the conventional probe.

### Example 5. Comparison of Protein Binding and Regeneration Between MgF₂ Probe and Conventional Probe

### Preparation of Anti-Mouse Fc Coated Probe

Streptavidin-coated probe was made by dipping the two APS probes (Examples 1 and 2A) into 50 μg/mL streptavidin (Invitrogen, 21122) in PBS buffer in 96 well plate for 10 min at 1000 rpm.

Affinity purified goat anti-mouse IgG Fc-gamma fragment specific (Jackson-Immuno, 115-005-071) was used in the experiment. This anti-mouse-Fc has minimal cross-reaction to human, bovine and horse serum proteins. The Anti-mouse IgG was biotinylated using a standard protocol with EZ-link NHS-PEG4-Biotin (Thermo Scientific, A39259). The biotinylated antibody was diluted in K buffer (Probe Life, 120011). The streptavidin-coated probes were dipped in 0.5 mg/ml biotin-anti-mouse-Fc for 10 minutes and washed for 30 seconds in K buffer to remove any non-specific binding interaction on the probe's surface.

### Assay

The anti-mouse Fc coated dried probes were soaked in Q buffer (PBS+0.2% BSA+0.02% Tween-20) and hydrated for 5 minutes before any assay.

Mouse-IgG concentrations ranging from 0.5-200 μg/ml were generated using mouse IgG dissolved in Q buffer. This concentration series was used to test the conventional probe vs the MgF₂ probe side-by-side to compare the performances of both probes in terms of binding capacity, signal intensity and regeneration. For regenerating both probes, 10 mM Glycine pH 1.75 with 150 mM NaCl was used as the regeneration solution.

The experiment was conducted using the Gator instrument from Probe Life, Inc. (GA007) and the software version 1.3. The samples as well as the regeneration solutions were prepared in the microplate from Greiner Bio (Ref #655209).

The reaction and regeneration protocols are shown in Table 3. The regeneration is repeated 10 times.

TABLE 3
Regeneration Test Results

| | | | | Shaking | |
|---|---|---|---|---|---|
| | | | Volume | speed | Time |
| Steps | Step type | Reagent | (μL) | (rpm) | (sec) |
| 1 | Reaction | Mouse IgG | 200 | 1000 | 300 |
| 2 | Regeneration | 10 mM Glycine | 200 | 1000 | 5 |
| | | pH 1.75 | | | |
| 3 | Neutralization | Q buffer | 200 | 1000 | 5 |

### Results

A side-by-side comparison of binding capacity of conventional probe versus MgF₂ probe was conducted to understand the binding intensity, binding rate and regeneration. The results are summarized in Tables 4 and 5.

Table 4 shows that the MgF₂ probe has much higher signal (nm wavelength shift) and faster binding rate than the conventional probe.

TABLE 4
Binding Capacity Results

| Concentration | Time of | Signal (nm shift) | | Rate (nm/sec) | |
|---|---|---|---|---|---|
| of mouse IgG | binding | MgF₂ | Conventional | MgF₂ | Conventional |
| (μg/mL) | (sec) | Probe | probe | Probe | probe |
| 30 | 300 | 2.4 | 1.8 | 0.11 | 0.08 |
| 3 | 300 | 1.6 | 1.25 | 0.02 | 0.02 |
| 0.3 | 300 | 0.55 | 0.35 | 0.002 | 0.001 |
| 0.03 | 300 | 0.1 | 0.07 | 0.0002 | 0.0001 |

Table 5 shows that after 10 rounds of regeneration, MgF₂ probes retained 52% (30 μg/mL mIgG) and 41% (3 μg/mL mIgG) of the original signal intensities, whereas the conventional probes only retained 29% (30 μg/mL mIgG) and 30% (3 μg/mL mIgG) of the original signal intensities.

TABLE 5
Regeneration Test Results

| | | MgF₂ | | Conventional |
|---|---|---|---|---|
| | | probe after | | probe after |
| Concentration | MgF₂ | 10 regen- | Conventional | 10 regen- |
| of mouse IgG | probe | eration | probe | eration |
| (μg/mL) | (nm Shift) | (nm Shift) | (nm Shift) | (nm Shift) |
| 30 | 2.4 | 1.25 | 1.8 | 0.52 |
| 3 | 1.6 | 0.65 | 1.25 | 0.38 |

### Example 6. Comparison of Small Molecule Binding Between MgF₂ Probe and Conventional Probe

In this example, the binding of an enzyme, carbonic anhydrase II (CAII), to one of its inhibitors, furosemide, was detected with the MgF₂ probe of Example 2B, and compared to a conventional bio-layer interferometry (BLI) sensor with SiO₂ optical layer. Also, an antibody, anti-estradiol, was tested for binding to its antigen, estradiol. Furosemide and estradiol are excellent models for small molecule label free detection since they have molecular weights of respectively 330 and 272 Daltons.

### Preparation of Materials

### Biotin Labeling of Bovine Carbonic Anhydrase II (CAII) and Human Anti-Estradiol Antibody

CAII (Sigma-Aldrich), anti-estradiol (US Biological), NHS-LC-LC-Biotin (ThermoFisher) were used in the biotinylation reaction. No further purification of the materials was performed prior to labeling reaction. CAII and anti-fluorescein antibody were labelled at a molar coupling ratio (MCR) of 1. Anhydrous DMF was used to dissolve the NHS-LC-LC-Biotin, added immediately to the respective protein, vortexed, and allowed to proceed for 1 hour at room temperature. Following the labeling reaction, the biotinylated proteins were purified using a PD-10 column (GE Healthcare).

### Preparation of Crosslinked FICOLL®

The method to prepare crosslinked FICOLL® was described in U.S. Pat. No. 8,309,369. To 2 ml of FICOLL® 400 (Sigma/Aldrich) that was aminated to contain 88 amines per FICOLL® 400 kD (Skold Technology) at 20 mg/ml in PBS was added 10 μL of SPDP (Invitrogen, succinimydyl 6-[3-[2-pyridyldithio]-proprionamido]hexanoate) at 50 mg/ml in DMF. The SPDP to FICOLL® molecular coupling ratio (MCR) was 15. The mixture reacted for 1 hour at room temperature followed by dialysis. Thiol incorporation was estimated to be 5.5 per FICOLL® 400 kD by standard methods.

To deprotect the thiols on SPDP labeled FICOLL® 400, 30 μL of DTT at 38 mg/ml PBS was added to 20 mg in 1 ml PBS and allowed to react for two hours at room temperature. The SH-FICOLL® was purified on a PD10 column.

SMCC was linked to aminated FICOLL® 400 (88 amines/FICOLL®) in two preparations as follows: 1.) Aminated FICOLL® 400 at 10 mg in 1 ml PBS was mixed with 25 μL SMCC at 10 mg/mL DMF for a SMCC/FICOLL® MCR of 30. The mixture reacted for two hours at room temperature followed by purification on a PD10 column (GE Healthcare). 2.) Aminated FICOLL® 400 at 10 mg in 1 mL PBS was mixed with 12.5 ul SMCC at 10 mg/mL DMF for a SMCC/FICOLL® MCR of 15. The mixtures reacted for 2 hours at room temperature followed by purification on a PD10 column.

To crosslink the SH-FICOLL® 400 and SMCC-FICOLL® 400, two preparations were made: 1.) 10 mg in 1 mL PBS SH-FICOLL® 400 was mixed with 10 mg in 1 mL PBS SMCC-FICOLL® 400 (30 MCR). 2.) 10 mg in 1 mL PBS SH-FICOLL® 400 was mixed with 10 mg in 1 mL PBS SMCC-FICOLL® 400 (15 MCR). The mixtures reacted for overnight at 30° C.

To provide the SH-FICOLL® 400 and SMCC-FICOLL® 400, two preparations were made: 1.) 10 mg in 1 mL PBS SH-FICOLL® 400 was mixed with 10 mg in 1 mL PBS SMCC-FICOLL® 400 at 30 MCR. 2.) 10 mg in 1 mL PBS SH-FICOLL® 400 was mixed with 10 mg in 1 mL PBS SMCC-FICOLL® 400 (15 MCR). The mixtures reacted for overnight at 30° C.

### Synthesis of Streptavidin-Crosslinked FICOLL® Conjugate

1 mg of SPDP labeled cross-linked FICOLL® was deprotected with 38 mg/mL DTT (ThermoFisher, 20290) dissolved in PBS, at an MCR of 592 at room temperature for 1 hour. 8 mg of streptavidin (SA) (Prozyme, SA10) was labelled with succinimidyl 4-(N-maleimidomethyl)cyclohexane-1-carboxylate (SMCC) dissolved in anhydrous DMF, at an MCR of 1, for 1 hour at room temperature. Following the SMCC labeling or DTT deprotection reactions, streptavidin (SA) or cross-linked FICOLL® were purified using a PD-10 column (GE Healthcare, 17085101). Purified cross-linked FICOLL® and SA were mixed in a 50 mL tube and the coupling reaction proceeded overnight at room temperature. On the next day, 12 μL of 16 mg/mL N-ethylmaleimide dissolved in PBS, was added to the reaction mixture and allowed to react for 30 minutes at room temperature, to cap unreacted cysteines. Following the capping reaction, the reaction mixture was purified on a 4B-CL column.

Coating of MgF₂ Probes with Streptavidin-Crosslinked FICOLL®

All shaking speeds were at 1000 rpm. MgF₂ probes (Example 2B) were first washed with ethanol for 120 seconds. The probes were then washed with PBS for 60 seconds, before coating with 100 μg/mL of streptavidin-crosslinked FICOLL® for 600 seconds. Two more PBS washes at 30 seconds each were performed, before coating the probes with 15% sucrose in PBS for 60 seconds, as a preservative for long term storage. The probes were then dried for 20 minutes in a 40° C. oven.

### Loading Biotinylated CAII and Biotinylated Anti-Estradiol on MgF₂ Probes

All shaking speeds were at 1000 rpm unless otherwise stated. The probes were first equilibrated in Q buffer for 120 seconds. Next, biotinylated CAII or biotinylated anti-estradiol was loaded at 10 μg/mL for 1800 seconds at 400 rpm on orbital shaker. 1 mM biocytin was loaded on the reference probes (probes containing no CAII) for subsequent double referenced experiments. A final wash for 60 seconds was performed.

### Loading Biotinylated CAII and Anti-Estradiol Antibody on Streptavidin SiO₂ Probes

All shaking speeds were at 1000 rpm unless otherwise stated. Octet SA probes (ForteBio, 18-5019) were first equilibrated in Q buffer for 120 seconds. Next, biotinylated CAII or anti-estradiol antibody were both loaded at 10 ug/mL for 1800 seconds at 400 rpm. 1 mM biocytin was loaded on the reference probes for referenced experiments. A final wash for 60 seconds was performed.

### Assay Protocol and Data Processing

### MgF₂ Probe Assays

All shaking speeds were at 1000 rpm. Assay and data acquisition were performed on the Gator™ instrument (GatorBio) at 30° C. Furosemide (Acros 448970010) was used at 10 μM and estradiol (Sigma-Aldrich, 1250008) was used at 6.4 nM. CAII or anti-estradiol antibody loaded probes were pre-wetted in assay buffer (PBS+0.05% DMSO) for 600 seconds before the start of the binding step. Next, a 60-second baseline was established in the assay buffer, followed by a 180-second association step with furosemide or estradiol in PBS with 0.05% DMSO. In a referenced experiment, biocytin-loaded probes on a second column, were then exposed to furosemide.

### MgF₂ Probe Data Processing

Estradiol and furosemide binding data was processed on Gator Data Analysis version 1.7.2 using the reference well subtraction option. The Y-axis is aligned to each baseline and averaged for the last 50 seconds. Savitzky-Golay filtering was applied to remove high frequency noise from the data. The binding curve data were then calculated and shown as wavelength shift in picometers (pm).

### Conventional Probe (SiO₂) Assays

All shaking speeds were at 1000 rpm. Assay and data acquisition were performed on the OctetRED instrument (ForteBio) at 30° C. The same assay protocols as described above for MgF₂ probes were used.

### Conventional Probe Data Processing

Furosemide data was processed on Octet Data Analysis 10.0 using the reference subtraction option. In the reference option, the furosemide binding signal obtained by subtracting the reference probe from the active furosemide probe.

Estradiol binding data was processed using reference probe subtraction option. In this option, binding signal obtained by subtracting the reference probe from the active estradiol probe.

In both cases, the y-axis is aligned to each baseline and averaged from 1 to 59 seconds. Savitzky-Golay filtering was applied to remove high frequency noise from the data. The binding curve data were then calculated and shown as wavelength shift in picometers (pm).

### Comparison Results Between MgF₂ Probe and Conventional Probe

Table 6 shows the comparison results of carbonic anhydrase/furosemide binding with MgF₂ and conventional SiO₂ probes. The binding signal of 10 μM furosemide to CAII on MgF₂ probes was 210.7 pm (picometer), which is 18-fold higher compared to 11.7 pm on conventional SiO₂ probes.

TABLE 6
Binding Signal Results

| | Binding Signal (pm shift) of 10 μM furosemide |
|---|---|
| Conventional probe | 11.7 |
| MgF₂ probe | 210.7 |

Table 7 shows the comparison results of anti-estradiol/estradiol binding with MgF₂ probe and conventional SiO₂ probes. Conventional SiO₂ probes produced a negligible binding signal (2 pm) while MgF₂ probes generated a significant binding signal of 90.9 pm.

TABLE 7
Binding Signal Results

| | Binding Signal (pm shift) of 6.4 nM estradiol |
|---|---|
| Conventional probe | 2 |
| MgF₂ probe | 90.9 |

What is claimed is:

1. An interferometric sensor for detecting an analyte in a sample, the interferometric sensor comprising:
a monolithic substrate that comprises glass that has first and second surfaces arranged substantially parallel to one another at opposite ends of the monolithic substrate;
an interference layer that comprises magnesium fluoride (MgF₂) coated on the second surface of the monolithic substrate; and
a layer of analyte-binding molecules coated on the interference layer;
wherein a first interface between the monolithic substrate and the interference layer acts as a first reflecting surface when light is shone on the interferometric sensor;
wherein a second interface between a biolayer formed by analyte molecules in a sample binding to the analyte-binding molecules and a solution containing the sample acts as a second reflecting surface when the light is shone on the interferometric sensor.

2. The interferometric sensor of claim 1, wherein the monolithic substrate has a length of at least 5 millimeters (mm), and wherein an aspect ratio of the monolithic substrate is at least 5 to 1.

3. The interferometric sensor of claim 1, wherein the interference layer has a thickness of at least 500 nanometers (nm).

4. The interferometric sensor of claim 1, further comprising:
an adhesion layer that comprises silicon dioxide (SiO₂) positioned between the interference layer and the layer of analyte-binding molecules.

5. The interferometric sensor of claim 4, wherein the adhesion layer has a thickness of less than 10 nm.

6. An interferometric sensor comprising:
a monolithic substrate that has first and second surfaces arranged substantially parallel to one another at opposite ends of the monolithic substrate;
an interference layer having a refractive index that is at least 0.1 less than a refractive index of the monolithic substrate; and
a layer of analyte-binding molecules to which analyte molecules in a sample bind during a biochemical test to form a biolayer,
wherein the refractive index of the interference layer is within 0.05 of the refractive index of the biolayer.

7. The interferometric sensor of claim 6, wherein a thickness of the interference layer is between 500 and 5,000 nm.

8. The interferometric sensor of claim 7, wherein the thickness of the interference layer is between 800 and 1,200 nm.

9. The interferometric sensor of claim 6, wherein the monolithic substrate comprises glass.

10. The interferometric sensor of claim 6, wherein the interference layer comprises magnesium fluoride.

11. The interferometric sensor of claim 6, wherein the refractive index of the monolithic substrate is at least 1.8.

12. The interferometric sensor of claim 6, further comprising:
an adhesion layer that connects the layer of analyte-binding molecules to the interference layer.

13. The interferometric sensor of claim 12, wherein the adhesion layer comprises silicon dioxide, and wherein the adhesion layer has a thickness of less than 10 nm.

14. The interferometric sensor of claim 6, wherein the monolithic substrate has a columnar form.

15. The interferometric sensor of claim 14, further comprising:
a flexible support component located in a central portion of the monolithic substrate,
wherein a first portion of the monolithic substrate extends from a top side of the flexible support component, and
wherein a second portion of the monolithic substrate extends from a bottom side of the flexible support component.

16. The interferometric sensor of claim 15, wherein the flexible support component includes a flange and a sleeve located beneath the flange.

17. The interferometric sensor of claim 15, wherein the flexible support component comprises silicone rubber.

18. The interferometric sensor of claim 15, wherein the flexible support component is configured to support the interferometric sensor when loaded into a well.

19. The interferometric sensor of claim 6, further comprising:
a reflection layer interconnected between the monolithic substrate and the interference layer,
wherein the reflection layer has a refractive index that is higher than the refractive index of the monolithic substrate and the refractive index of the interference layer.

20. A method for manufacturing the interferometric sensor according to claim 1, the method comprising:
acquiring a monolithic substrate;
polishing first and second surfaces of the monolithic substrate that are arranged substantially parallel to one another at opposite ends of the monolithic substrate;
depositing a first transparent material that comprises magnesium fluoride (MgF₂) on the second surface of the monolithic substrate to form an interference layer; and
binding analyte-binding molecules to the interference layer.

21. The method of claim 20, wherein the monolithic substrate comprises glass.

22. The method of claim 20, wherein the interference layer has a thickness of at least 900 nm.

23. The method of claim 20, further comprising:
depositing a second transparent material on the interference layer to form an adhesion layer,
wherein the layer of analyte-binding molecules is bound to the adhesion layer.

24. The method of claim 23, wherein the second transparent material is silicon dioxide.
